(19) United States
(12) Patent Application Publication
(10) Pub. No.: US 2008/0225064 A1
(43) Pub. Date: Sep. 18, 2008

(54) PRINTING SYSTEM

(75) Inventor: Kenichi Udagawa, Tokyo (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Joso-shi (JP)

(21) Appl. No.: 12/044,920

(22) Filed: Mar. 7, 2008

(30) Foreign Application Priority Data
Mar. 12, 2007 (JP) 2007-062131

(51) Int. Cl. B41J 2/195

(52) U.S. Cl. 347/7

(57) ABSTRACT

In a printing system including a plurality of inkjet printing units and an ink tank commonly used thereby, wherein the ink tank is capable of notifying an amount of ink consumed thereby and has a memory for storing information relating to the ink consumption amount in a updatable manner, the memory access by the printing units is properly arbitrated. The printing system is provided with a storage section for storing the ink consumption amount notified from the respective printing units, a process section for reading the information from the memory and carrying out the calculation together with the stored ink consumption amount, a process section for updating the content in the memory based on the calculated value, and a process section for suspending the calculation relating to the amount of ink consumption in one printing unit, when the calculation is being carried out about any other printing units.

### BACKGROUND OF THE INVENTION

1. Field of the Invention

The present invention relates to a printing system comprising a plurality of inkjet printing apparatuses and an ink tank commonly used thereby.

2. Description of the Related Art

Presently, the inkjet printing apparatuses have been used in various applications such as industrial uses, office uses or personal uses (for individual or domestic). Accompanied therewith, various printing media have been used. Particularly in the industrial field, sizes thereof are in a wide range from relatively small ones such as labels attached to commercial goods or packages thereof to relatively large ones exceeding A2-size (420 mm×594 mm). Further, a capacity for processing a large amount of prints in a stable manner at a high speed is markedly desired for the printing apparatuses used in the industrial field.

For this purpose, a printing system capable of carrying out the printing on a wider printing medium or at a higher speed has been proposed, wherein a plurality of inkjet printing apparatuses are arranged to be cooperative to each other for the printing on a printing medium. In such a printing system, a common ink tank that is a source of ink supplied to the plurality of inkjet printing apparatuses is generally used in view of the easiness of the operation for exchanging the ink tank by the user. The common use of the ink tank described above is disclosed, for example, in Japanese Patent Laid-Open No. 2002-264360.

On the other hand, when the ink is being consumed to be substantially no ink in the ink tank, a proper amount of ink may not be supplied to the inkjet printing apparatuses. In such a case, even if the printing operation hardly could be continued, there may be unfavorable results such as fuzzy images or others. Accordingly, it is necessary to properly know a time at which the ink tank should be exchanged and inform the same to the user so that the ink tank is promptly exchanged. Particularly, in the industrial printing apparatuses, since a large amount of unfavorably printed products may generate if the proper amount of ink is not supplied, there is a higher necessity for accurately knowing the time for exchanging the ink tank. For this purpose, it is necessary to be aware of how much ink has been consumed as well as what amount of ink is remaining in the ink tank.

In the prior art, to control the amounts of consumed ink or the residual ink, there is an inkjet printing apparatus on which a nonvolatile memory is mounted (for example, see Japanese Patent Laid-Open No. 2003-370382). According to this printing apparatus, the number of ink ejections during the printing operation (a dot count value) is counted. By using ink consuming information corresponding to this count value (or a value obtained by multiplying this by an ink amount per one ejection), the information relating to the amounts of consumed ink stored in the memory is updated so that the amount of residual ink is controlled. When the amount of residual ink substantially becomes null or such a state is forecast, this fact is notified to the user via the printing apparatus or a host apparatus connected thereto, whereby the exchange of the ink tank or the preparation thereof is urged.

In the mechanism wherein a plurality of inkjet printing apparatuses are arranged to cooperate with each other for the printing operation on the medium, however, it is impossible to directly apply the technology disclosed in Japanese Patent Laid-Open No. 2002-370382. This is because the memory access (transmission and receiving of data) is carried out from each inkjet printing apparatus at an independent timing for the purpose of updating the information of the ink amount stored in the memory of the ink tank, which may result in the simultaneous memory access.

### SUMMARY OF THE INVENTION

An object of the present invention is that in a structure wherein a plurality of inkjet printing apparatuses using a common ink tank are arranged to cooperate with each other for carrying out the printing operation on a printing medium, the memory accesses are properly arbitrated.

In the present invention, there is provided a printing system comprising a plurality of inkjet printing apparatuses and ink tanks commonly used by the plurality of inkjet printing apparatuses; each of the plurality of inkjet printing apparatus being capable of notifying an amount of ink consumed thereby and the ink tank having a memory unit capable of storing information relating to the amount of ink consumption in a updatable manner; the printing system comprising:

a memory access controller provided between the plurality of inkjet printing apparatuses and the ink tanks, the memory access controller having:

a storage section for storing the amount of ink consumption notified from each of the plurality of inkjet printing apparatuses;

a process section for reading the information from the memory unit of the ink tank and carrying out the calculation together with the stored amount of ink consumption;

a process section for updating the memory content in the memory unit of the ink tank by the calculated value; and

a process section for determining, prior to carrying out the calculation relating to the amount of ink consumption in one inkjet printing apparatus, whether or not the calculation is being carried out, relating to the amount of ink consumption in any other inkjet printing apparatus, and if the determination is affirmative, suspending the calculation for the one inkjet printing apparatus.

According to the present invention, even if the memory access is individually carried out from each of the inkjet printing apparatuses to update the information relating to the amounts of ink consumption (a accumulative value of the ink consumption or a residual amount of ink) stored in the memory unit of the ink tank, this is arbitrated by a memory access controller. Thus, each of the inkjet printing apparatus is capable of carrying out the memory access operation at a proper timing without considering the memory access of the other inkjet printing apparatuses. Accordingly, it is possible that the printing system smoothly carries out the starting operation, the printing operation and the recovery operation while avoiding the disappearance of the notified data or the generation of the erroneous computation.

Further features of the present invention will become apparent from the following description of exemplary embodiments (with reference to the attached drawings).

### BRIEF DESCRIPTION OF THE DRAWINGS

FIG. 1 is a schematic side view illustrating a structure of an inkjet printing apparatus applied to the inventive printing system as a printing unit for carrying out the printing operation on a printing medium in cooperation with the other inkjet printing apparatuses, in a non-printing state;

FIG. 2 is a schematic side view illustrating a structure of the inkjet printing apparatus applied to the inventive printing system as a printing unit for carrying out the printing operation on the printing medium in cooperation with the other inkjet printing apparatuses, in a printing state;

FIG. 3 is a schematic plan view of an embodiment of a printing apparatus wherein a plurality of printing units are arranged in cooperation with each other in the printing system;

FIG. 4 is an illustration of one aspect wherein the plurality of printing units arranged in correspondence to FIG. 3 cooperatively print an image;

FIG. 5 is an illustration of another aspect wherein the plurality of printing units arranged in correspondence to FIG. 3 cooperatively print an image;

FIG. 6 is a block diagram illustrating an embodiment of a control system for the printing unit;

FIG. 7 is a schematic view illustrating an ink supplying system of a printing system according to one embodiment of the present invention:

FIG. 8 is a schematic view illustrating one example of electric connections between the respective sections in the printing system according to one embodiment of the present invention;

FIG. 9 is a schematic view illustrating one example of a structure of an ink tank unit according to one embodiment of the present invention;

FIG. 10 is a schematic view illustrating one example of a structure of an ink distribution unit according to one embodiment of the present invention:

FIG. 11 is a block diagram illustrating one example of an electric structure of the ink distribution unit for actualizing the respective functional blocks shown in FIG. 10;

FIG. 12 is a flow chart illustrating one example of a procedure executed by the ink distributing unit for accumulatively writing dot count values of the respective printing units on the nonvolatile memory of the ink tank unit; and

FIG. 13 is a flow chart illustrating one example of a procedure executed by the ink distribution unit for reading dot count values stored in the nonvolatile memory of the ink tank unit.

### DESCRIPTION OF THE EMBODIMENTS

The present invention will be described in detail hereinafter with reference to the drawings described above.

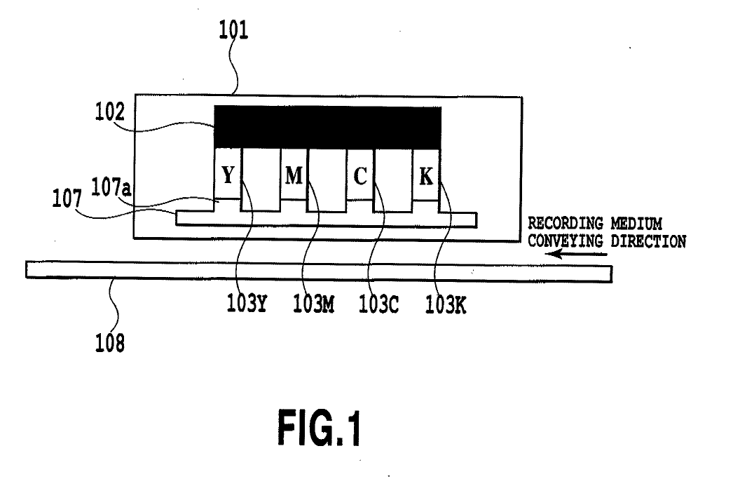

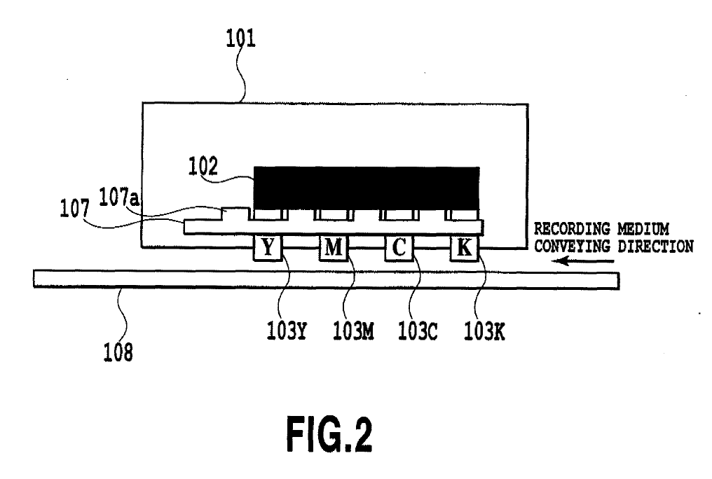

FIGS. 1 and 2 are schematic side views illustrating a structure of an inkjet printing apparatus as a unit for carrying out the printing operation on a printing medium in corporation with the other (hereinafter referred to as a printing unit).

The printing unit 101 is provided with printing heads 103K, 103C, 103M and 103Y for ejecting black (K), cyan (C), magenta (M) and yellow inks, respectively, so that a full color printing is carried out on a printing medium 108. In this regard, the print head is identified by a reference numeral 103 unless the color is specified. The print head 103 has ink ejection openings arranged in the widthwise direction of the printing medium 108 along a length of approximately 4 inches at a predetermined density. In the illustrated example, while the printing medium 108 has a continuous form, it may, of course, be of a cut sheet form. Also, the arrangement sequence of the color print heads in the conveying direction of the printing medium should not be limited to the illustrated one, but each of the plurality of printing units used in the embodiment is preferably has the same arrangement sequence so that the overlap sequence of the colors on the printing medium becomes equal.

In the printing unit 101, the print heads 103 are detachably held by a holding section 102 and movable up and down in the vertical direction together with the holding section 102. Also, a recovery unit 107 having caps 107a corresponding to the print heads 103 is held to be movable in the horizontal direction.

FIG. 1 illustrates a state wherein no printing operation is carried out and the caps 107a are in contact with ejection opening-forming surfaces of the print head 103, such as when the printing apparatus is stored or on stand-by. If the ejection opening-forming surface of the print head is exposed to an atmosphere when no printing operation is carried out, there may be a risk in that ink solvent evaporates in the vicinity of the ejection opening, which results in the increase in the ink viscosity or solidification of the ink, or the adhesion of dust, causing the faulty ejection. To avoid such defects, the ejection opening-forming surface is capped during the non-printing state. The print head of an inkjet head form is preferably subjected to the recovery operation for maintaining or recovering the favorable ink ejection state. FIG. 1 also illustrates a state capable of carrying out such the recovery operation by the recovery unit 107. The recovery operation includes a pressurization recovery operation for pressurizing an ink supply system to circulate ink to the print head or forcibly discharge ink from the ejection openings, and a preliminary ejecting operation for preliminarily forcing the print head to eject ink prior to the printing. Also, this includes the cleaning operation for wiping the ejection opening-forming surface of the print head with a wiper blade made, for example, of rubber. The recovery unit 107 has parts for carrying out these operations.

When shifting from the state shown in FIG. 1 to the printing operation, the holding section 102 is once lifted and then the recovery unit 107 is retreated leftward so that openings provided between the adjacent caps 107a are opposed to the print heads 103. Then, the holding section 102 descends so that the print heads 103 project downward from the openings of the recovery unit 107 as shown in FIG. 2 to locate the former at positions opposite to the printing medium 108 at a predetermined gap between the both, whereby a state is obtainable wherein the printing operation (ink ejection) is possible. When the non-printing state is set from this state, the procedure reverse thereto is carried out.

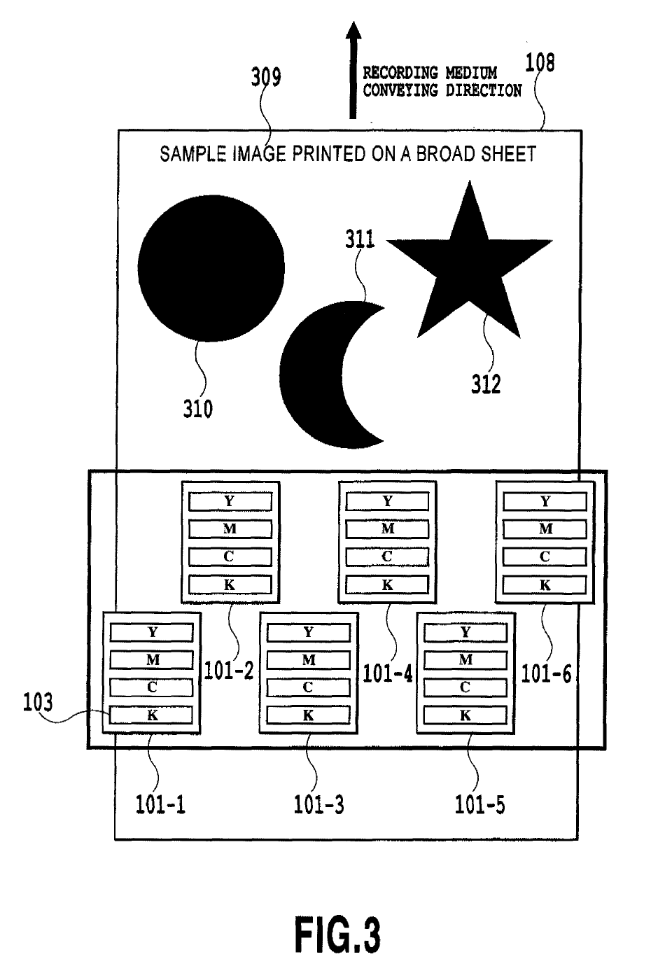

FIG. 3 is a schematic plan view of an example of a printing apparatus 301 in a printing system wherein a plurality of the above-mentioned printing units are arranged to cooperate with each other for the printing operation. The printing units 101-1 to 101-6 corresponding to the printing unit 101 in FIG. 1 and identified by a reference numeral 101 if not specified are arranged in the widthwise direction (vertical to the conveying direction) of the printing medium 108 to cover a width of the printing medium 108. That is, since the ink ejection openings of the respective printing heads in the respective printing units are arranged in the widthwise direction of the printing medium over a length of approximately 4 inches, the maximum printing width of approximately 24 inches (approximately 600 mm) is covered as a whole. According to such a structure, it is possible to print images containing characters 309 and FIGS. 310 to 312 on the printing medium 108 having a wide width by the cooperation of the printing units 101-1 to 101-6.

Here, a group of the printing units 101-1, 101-3 and 101-5 and another group of the printing units 101-2, 101-4 and 101-6 are arranged to be off to each other in the conveying direction of the printing medium. That is, the printing units 101-1 to 101-6 are arranged in a zigzag manner.

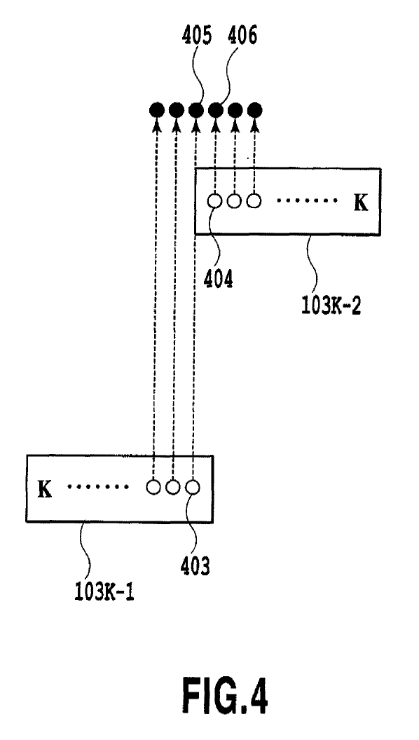

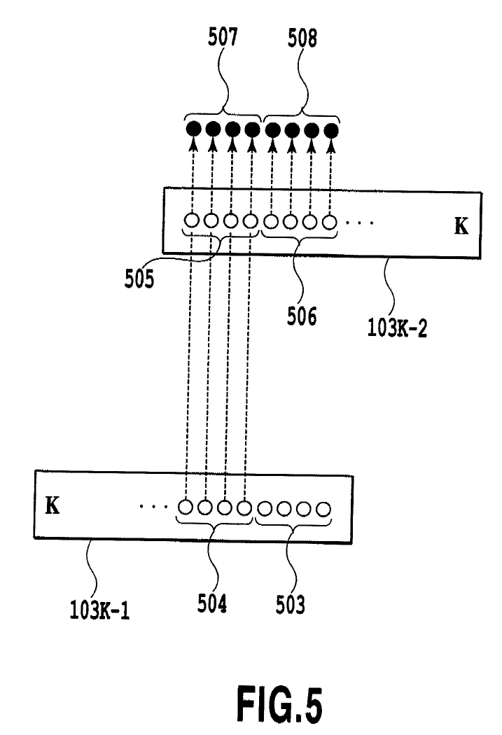

By using FIGS. 4 and 5, a reason for providing the above-mentioned zigzag arrangement and an aspect for carrying out the image printing by the mutual cooperation of the printing units in correspondence to such the arrangement will be explained. In this regard, in these drawings, the relationship is illustrated between the print heads 103-1 and 103-2 belonging to the printing units 101-1 and 101-2, respectively.

As shown in FIG. 4, the ink ejection opening provided at an end of the arrangement direction is generally located at a position apart from an end surface of a body of the print head. Accordingly, if the print heads or the printing units are simply arranged on a single line in the widthwise direction of the printing medium, a distance between the ejection openings 403 and 404 provided at the ends of the print heads 103K-1 and 103K-2 becomes too long to form dots connected to each other in the lateral direction. For this reason, by arranging the printing units 101-1 to 101-6 in a zigzag manner as shown in FIG. 3, the dots continued in the lateral direction are securely formed. In other words, as shown in FIG. 4, the dots 405 and 406 adjacent to each other in the widthwise direction of the printing medium are formed by the ejection openings 403 and 404 located at the ends of the print heads 103K-1 and 103K-2.

By taking the manufacturing variance or the attachment error of the print head or the attachment error of the printing unit into consideration, it is also possible to arrange a plurality of ejection openings located at the ends of the print heads 103K-1 and 103K-2 to overlap with each other in the conveying direction of the printing medium as shown in FIG. 5. In the example shown in FIG. 5, eight ejection openings overlap with each other so that a dot group 507 is formed by an ejection opening group 504 of the print head 103K-1 and another dot group 508 is formed by an ejection opening group 506 of the print head 103K-2. The ejection opening group 503 of the print head 103K-1 and the ejection opening group 505 of the print head 103K-2 are provided for correcting the lateral deviation of the printing units 101-1 and 102-2 generated due to the attachment error or others. For example, when the printing unit 101-1 is deviated leftward in the drawing by one dot, the dot group 507 is formed by using rightward three ejection openings in the ejection opening group 504 and the leftmost one ejection opening in the ejection opening group 503.

Note that the arrangement of the printing units 101-1 to 101-6 should not be limited to that shown in FIG. 3, but may be changeable with reference to the printing direction or the sequence of data transfer.

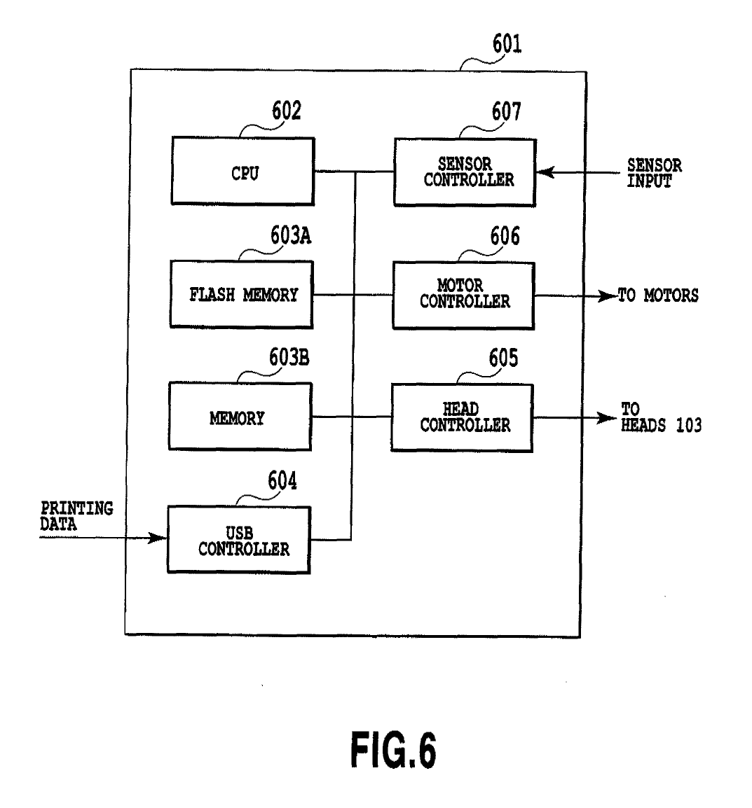

FIG. 6 illustrates an example of a control system for the printing unit 101, wherein parts described below are mounted on a substrate 601. CPU 602 is operated by a program stored in a flash memory 603A. That is, printing data (data divided into six groups in correspondence to positions of the printing unit) received from an information processing apparatus not shown such as a personal computer via a USB controller 604 are processed after being once expanded in a memory 603B, and are transmitted to a head controller 605 wherein the printing operation is carried out. At that time, signals for detecting a front end of the printing medium 108, setting a printing top position or corresponding to the arrangement position of the printing unit 101 are received from the information processing apparatus or the conveying device for the printing medium 108, and the process for synchronizing the ink ejection operation with the signals is carried out. Further, before and after the printing, the positions of the holding section 102 and the recovery unit 107 (see FIGS. 1 and 2) are properly set by controlling motors for the respective parts via a motor controller 606 while monitoring inputs from sensors connected via a sensor controller 607.

The printing unit 101 can count, by known means, the number of ejections (dot counts) from the ejection openings of the respective color print heads necessary for processing (printing) the printing data during the expansion of the above-mentioned received printing data, and notify the dot count value to an ink distribution unit 716 described later.

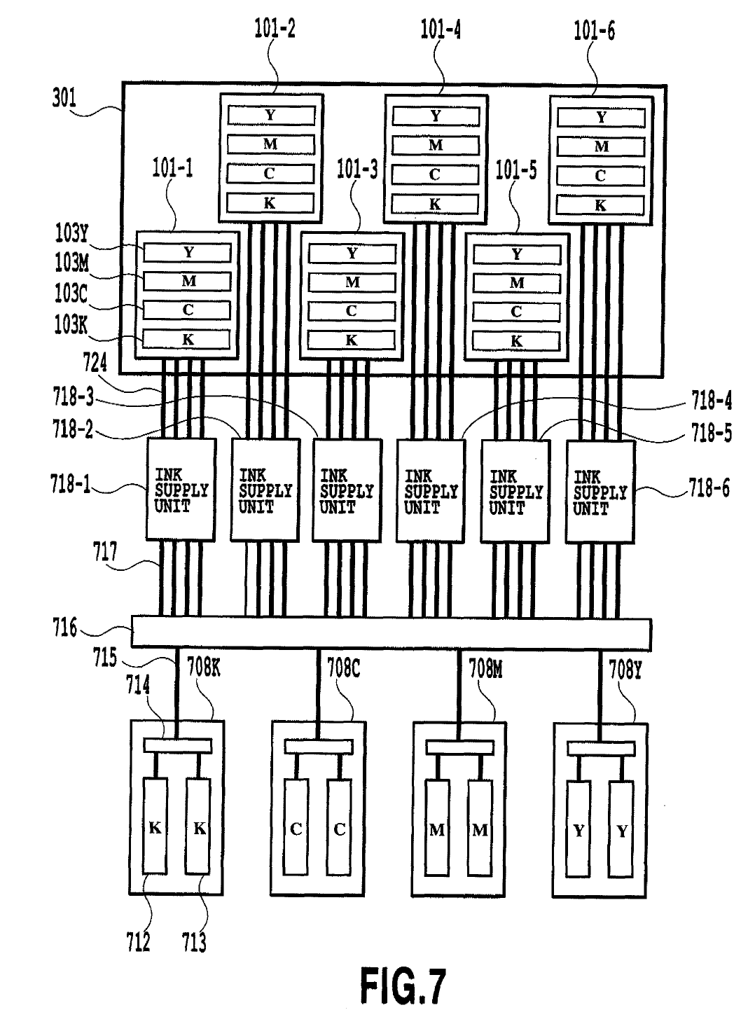

FIG. 7 is a schematic view illustrating one example of an ink supplying system in the printing system according to the present invention. The respective color inks are supplied to the print heads 103Y, 103M, 103C and 103K in the respective printing units 101 from ink tank units 708K, 708C, 708M and 708Y through tubes 715, 717 and 724. Reference numerals 718-1 to 718-6 denote ink supply units inserted between the tubes 717 and 724 and provided corresponding to the respective printing units 101-1 to 101-6, carrying out the operation necessary for the ink supply and the recovery for the printing units. That is, a sub-tank (not shown) for each of the respective color inks is prepared in the ink supply unit, and when the ink in the sub-tank has been consumed, new ink is pulled therein from the ink tank unit via the tube 715. The ink pulled in the sub-tank is supplied to the printing unit during the printing via through the tube 724. Also, during the recovery process, the pressurization is carried out for circulating ink between the sub-tank and an ink supply passage to the print head or forcibly discharging ink from the ejection opening.

Reference numeral 716 denotes an ink distribution unit describe later, for distributing the respective color inks supplied from the respective color ink tank units via the tubes 715 into the respective ink supply units via the tubes 717. In each of the ink tank units 708K, 708C, 708M and 708Y (hereinafter referred to as 708 if not specified), two ink tanks 712 and 713 are detachably mounted as an ink supply source. An ink supply passage is defined by a switch-over section 714 so that ink is generally supplied from one of these ink tanks. When the residual of ink becomes substantially null in the one ink tank, the connection is switched so that ink is supplied from another ink tank. Or, the connection may be switched at a proper timing or by a command from the user.

Note that the number of the ink tanks or those of the tubes 715, 717 and 724 may be, of course, properly selected.

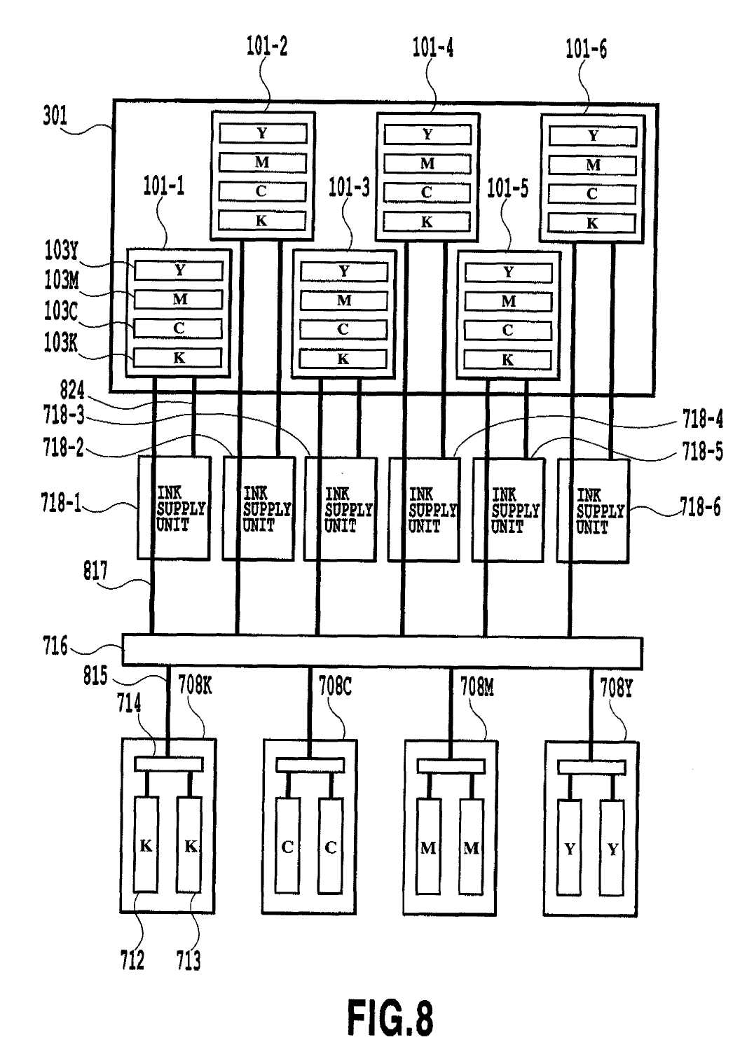

FIG. 8 is a schematic view illustrating an example of the structure for the electric connection between the respective parts in the printing system. The printing units 101 and the ink tank units 708 are connected to each other by control signal lines 817 and 815 via the ink distribution unit 716. Also, the printing units 101 and the ink supply units 718 are connected to each other by control signal lines 824 so that the operation of the ink supply units 718 is controlled during the ink supplying process and the recovery process described above.

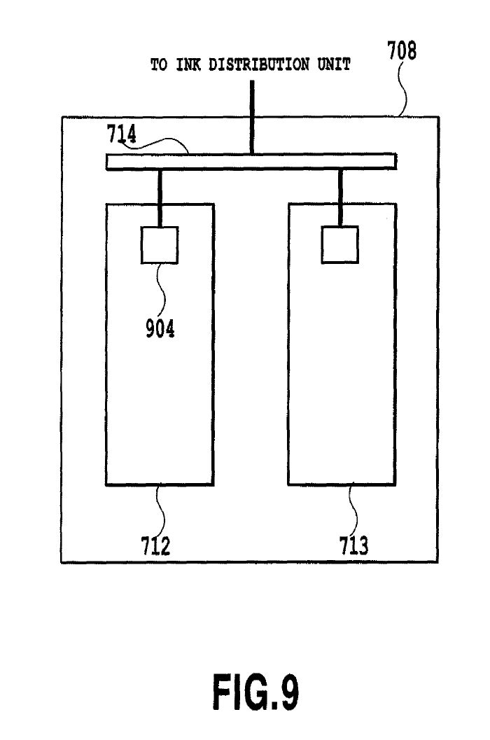

FIG. 9 is a schematic view illustrating an example of the structure of the ink tank unit. Each of the ink tanks 712 and 713 removably mounted to the ink tank unit 708 is provided with a nonvolatile memory 904 such as EEPROM. In the nonvolatile memory 904, information necessary for knowing the amount of residual ink is stored, in addition to a serial number for identifying the ink tank, a color of the ink contained therein, and information whether or not the connection for supplying ink exists. The above-mentioned necessary information includes, for example, the accumulative value of the number of ejections from the respective ejection openings (dot count value) when the printing operation is carried out in the printing unit 101. The switch-over section 714 switches over the electric connection of the nonvolatile memory 904 of the ink tank 712 or 713 in synchronism with the switching-over of the ink supply connection to define to allow or not the access to the nonvolatile memory.

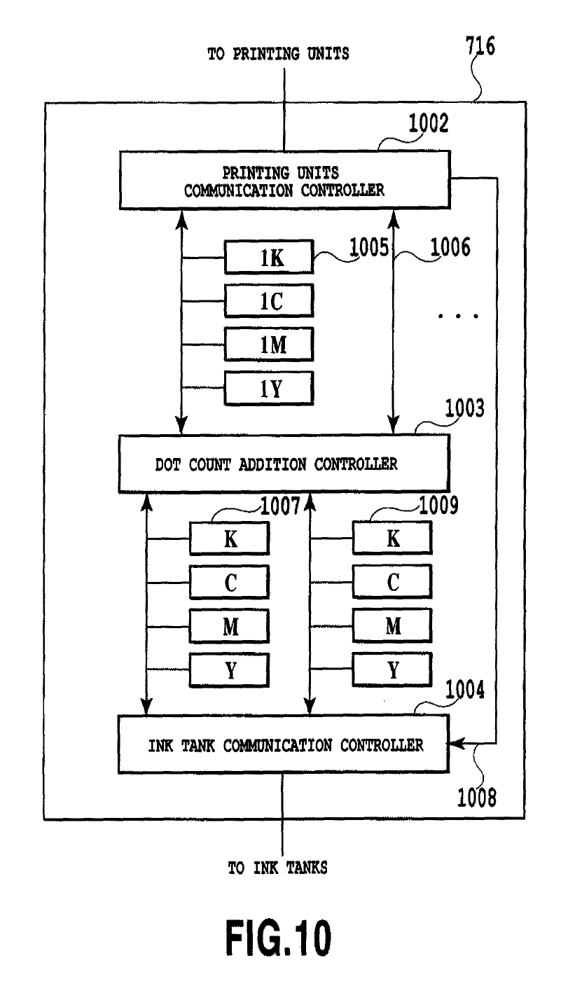

FIG. 10 is a schematic view illustrating an example of a structure of a memory access controller provided integral with the ink distribution unit 716. The ink distribution unit mainly includes a printing unit communication controller 1002, a dot count addition controller 1003 and an ink tank communication controller 1004. Memories 1005 are connected with the printing unit communication controller 1002 and the dot count addition controller 1003. The memories 1005 temporarily store the dot count values of the respective color inks notified from the printing unit 101 or the accumulative value of the dot count read from the nonvolatile memory 904 of the ink tank. If the memories 1005 are of a FIFO type, the printing unit 101 can notify the dot count value at a proper timing, and the ink distribution unit 716 stores a plurality thereof and sequentially provides the same to the addition process. Note that while the memories 1005 corresponding to one printing unit are solely shown in the drawing, they are provided to each of the printing units 101-1 to 101-6. Thereby, it is possible to separately store the dot count values of the respective printing units.

Between the printing unit communication controller 1002 and the dot count addition controller 1003, an interrupt signal line 1006 is connected for informing that there is a write demand or a read demand issued from the printing unit 101.

In this regard, there may be a case wherein, when one printing unit is being processed after a certain printing unit has been processed; the demand for adding the dot count is again issued from the latter. For responding to such a case, a plurality of memories 1005 are preferably provided corresponding to the plurality of print units for allowing to store such a dot count in view of the switch-over time of the ink distribution units as well as a writing time to the nonvolatile memory 904 of the ink time accompanied with the exchange.

Nonvolatile memories 1007 and 1009 for the respective color ink are connected to the dot count addition controller 1003 and the ink tank communication controller 1004. The memory 1007 accumulatively stores dot count values before being added to the nonvolatile memory 904. The memory 1009 temporarily stores the dot count accumulative value read from the nonvolatile memory of the ink tank, prior to being added with a new dot count value.

The above-mentioned memories 1005, 1007 and 1009 may not be individually prepared, but a storage area of a single memory may be divided for this use.

A write control signal 1008 from the printing unit communication controller 1002 is input into the ink tank communication controller 1004. This controls the timing for writing the added value obtained by the dot count addition controller 1003 on the nonvolatile memory 904 of the ink tank as a new accumulative value. In this regard, while this write control signal 1008 is illustrated in FIG. 10 as if four color components are in one group, the signal 1008 for each of the colors may be individually prepared. Also, when the writing has been done from the printing unit, the writing may be done on the nonvolatile memory 904 of the ink tank in each case, instead of preparing the write control signal 1008.

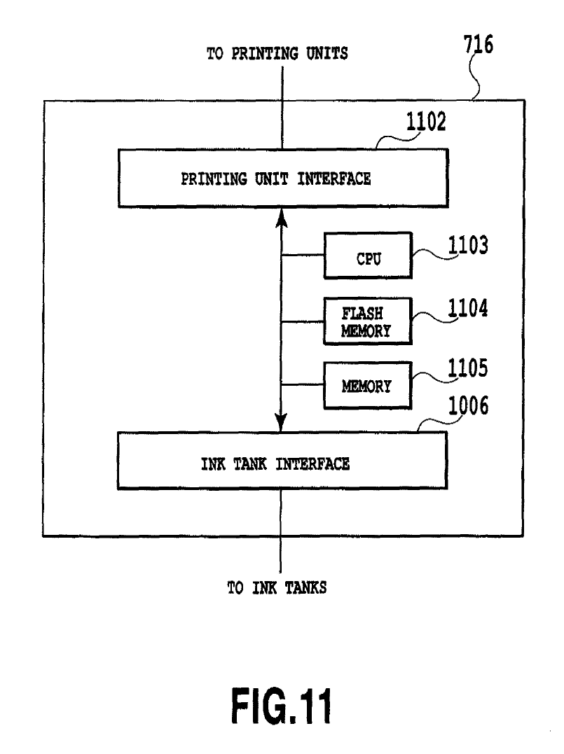

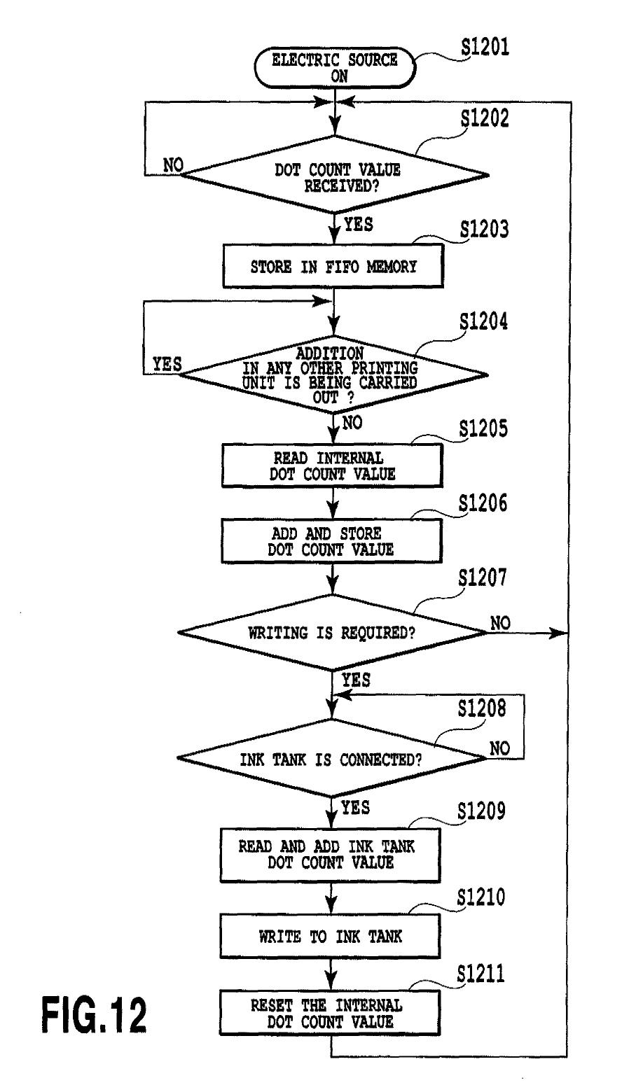

FIG. 11 is a block diagram illustrating an example of an electric structure of the ink distribution unit 716 for actualizing the memory access controller having the functional blocks shown in FIG. 10. The ink distribution unit 716 is connected to the printing units 101 via a serial communication interface 1102, and to the nonvolatile memory 904 of the ink tank via a serial communication interface 1106. A memory 1105 corresponds to the above-mentioned memories 1005, 1007 and 1009. CPU 1103 controls the ink distribution unit 716 so that the above-mentioned functional blocks are operated in accordance with a program stored in a flash memory 1104, corresponding to the procedure shown in FIG. 12 and described later.

In this embodiment, while the ink distribution unit 716 is controlled by software; i.e., the program executed by CPU, this may be replaced by hardware using control circuits such as ASIC or PLD. The connection of the printing unit 1101 with the nonvolatile memory 904 of the ink tank should not be limited to a serial communication system but a parallel communication system or others may be adoptable. In either case, the use of interface having a communication speed not stopping the process is preferable.

FIG. 12 is a flow chart illustrating an example of the procedure executed by the ink distribution unit for accumulatively writing the dot count values of the respective printing units on the nonvolatile memory of the ink tank unit.

This procedure is properly started after the electric power for a main body of the printing system has been on (at step S1201). First, when the printing unit communication controller 1002 receives the dot count value from the printing unit (at step S1202), this value is once stored in the memory 1005 of a FIFO (First-In First-Out) type (at step S1203). Then, it is confirmed whether or not the dot count addition controller 1003 carries out the adding operation of the dot count value for any other printing unit (at step S1204). If the answer is negative, the preceding dot count accumulative value to which the adding operation has not been yet been finished (if the updating of the accumulative value of the nonvolatile memory 904 has been finished, this value is supposed to be ‘0’) is read from the memory 1007 (at step S1205). Then, the value newly stored to the memory 1005 is added thereto and the result is written again on the memory 1007 (at step S1206).

Next, it is determined whether or not the printing unit 101 requires the writing of the dot count value (at step S1207). If the answer is affirmative, the updating of the accumulative value is carried out as follows, after the normal attachment of the ink tank has been confirmed (at step S1208). That is, the ink tank communication controller 1004 reads the dot count accumulative value from the nonvolatile memory 904 of the ink tank and once stores in the memory 1009. The value thus stored and a non-added value saved in the memory 1007 are added together (at step S1209). Then, the added value is written on the nonvolatile memory 904 of the ink tank to update the memory content (at step S1210). When the writing on the ink tank has finished, a value in the memory 1007 is reset to ‘0’ (at step S1211).

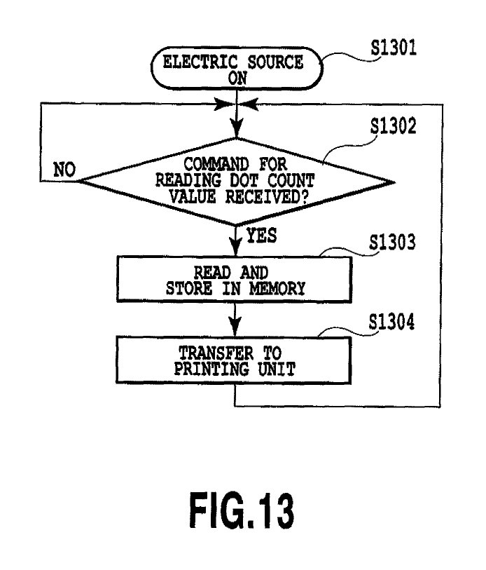

FIG. 13 is a flow chart illustrating an example of a procedure executed by the ink distribution unit for the purpose of reading the dot count accumulative value stored in the nonvolatile memory of the ink tank.

This procedure is properly started after the electric power for the main body of the printing system has been on (at step S1301). When the printing unit communication controller 1002 receives the reading demand from the printing unit (at step S1302), the dot count accumulative value is once read from the non-volatile memory 904 to the memory 1009, and then stored in the memory 1005 (at step S1303). This value is then transmitted to the printing unit 101 (at step S1304).

In correspondence to this transmitted value, the printing unit 101 or an information processor connected thereto as a higher-level device is executable the following procedure. For example, it is possible to determine whether or not the dot count accumulative value read thereby reaches a predetermined dot count value corresponding to the initial ink containing capacity of the ink tank, and, if the answer is affirmative, to inform the user so that the ink tank should be exchanged. Information means may be visual ones such as an indication lamp or a display generally used in an information processor of a personal computer type, or auditory ones such as a buzzer. In addition, according to this embodiment, since two ink tanks are provided in each of the ink tank units, it is possible to command the switch-over of the ink supply and the electric connection therebetween.

As described hereinbefore, according to this embodiment, it is possible to easily write the dot count values of six printing units on four ink tank units. Also, by providing a temporary storage area in the ink distribution unit 716, it is possible to properly respond even if the access is made in an overlapped manner from a plurality of printing units or the ink tank is not yet connected during the exchange thereof.

While the description has been made on the embodiment having six printing units and four ink tank units wherein two ink tanks are mountable to each of the ink tank units, these numbers are mere examples. That is, if a plurality of printing units (an inkjet printing apparatus) commonly use a less number of ink tanks, the present invention is effectively applicable. For example, the number or kind of ink color tones may be appropriately selectable, and, in correspondence thereto, the number of the ink tank units or the ink tanks and the number of the print heads in the printing unit may be optional.

Also, in the above-mentioned embodiment, the dot count value corresponding to an amount of ink used during the printing operation is accumulatively controlled. However, not only the number of ink ejections (the dot count value) during the printing, but also the ink amount consumed widely in the printing units, such as the number of preliminary ejections or an ink amount discharged during the recovery operation could be taken into consideration. Also, by subtracting, at a proper time, the dot count value corresponding to the consumed amount of ink from the dot count value corresponding to the initial containing capacity, it is possible to control the residual amount of ink. That is, information relating the consumed amount of ink stored in the nonvolatile memory of the ink tank may be not only the consumed amount of ink but also the residual amount of ink.

In the above-mentioned embodiment, while the switch-over of the electric connection to the nonvolatile memory in the ink tank is carried out in the switch-over section 714, it may be carried out in the ink distribution unit 716.

In addition, in the above-mentioned embodiment, the memory access controller for arbitrating the memory accesses from a plurality of printing units, that is, the memory access controller having the functional blocks as shown in FIG. 10 and capable of carrying out the operation shown in FIGS. 12 and 13, is provided in the ink distribution unit 716. The memory access controller may be provided separately from the ink distribution unit 716. In such a case, the ink distribution unit for distributing ink to the respective printing units by branching tubes from the ink tank unit and connecting the same to the printing units is not indispensable but the respective tubes may directly be connected to the printing units.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-062131, filed Mar. 12, 2007, which is hereby incorporated by reference herein in its entirety.

What is claimed is:

1. A printing system comprising a plurality of inkjet printing apparatuses and ink tanks commonly used by the plurality of inkjet printing apparatuses; each of the plurality of inkjet printing apparatus being capable of notifying an amount of ink consumed thereby and the ink tank having a memory unit capable of storing information relating to the amount of ink consumption in a updatable manner; the printing system comprising:
a memory access controller provided between the plurality of inkjet printing apparatuses and the ink tanks, the memory access controller having:
a storage section for storing the amount of ink consumption notified from each of the plurality of inkjet printing apparatuses;
a process section for reading the information from the memory unit of the ink tank and carrying out the calculation together with the stored amount of ink consumption;
a process section for updating the memory content in the memory unit of the ink tank by the calculated value; and
a process section for determining, prior to carrying out the calculation relating to the amount of ink consumption in one inkjet printing apparatus, whether or not the calculation is being carried out, relating to the amount of ink consumption in any other inkjet printing apparatus, and if the determination is affirmative, suspending the calculation for the one inkjet printing apparatus.

2. A printing system as claimed in claim 1, wherein the ink tank is detachably mounted thereon, and even if the ink tank is in a detached state, the storing of the amount of ink consumption in the storage section is possible in response to the notification.

3. A printing system as claimed in claim 1, wherein the storage section has a FIFO type memory and is capable of storing a plurality of amounts of ink consumption notified from the ink tank.

4. A printing system as claimed in claim 1, wherein the updating is carried out at a timing required by the inkjet printing apparatus.

5. A printing system as claimed in claim 1, further comprising an ink distribution unit for distributing ink supplied from the ink tank to the plurality of inkjet printing apparatuses, wherein the memory access controller is integrally provided with the ink distribution unit.
